(19) United States
(12) Patent Application Publication
(10) Pub. No.: US 2022/0382237 A1
(43) Pub. Date: Dec. 1, 2022

(54) ACCESSORY CONTROL SYSTEM AND KIT FOR A VEHICLE AND METHOD FOR CONFIGURING A VEHICLE

(71) Applicant: BOMBARDIER RECREATIONAL PRODUCTS INC., Valcourt (CA)

(72) Inventors: Joel COTE, Sherbrooke (CA); Mathieu LEBLOND, Drummondville (CA)

(21) Appl. No.: 17/828,178

(22) Filed: May 31, 2022

Related U.S. Application Data
(60) Provisional application No. 63/202,191, filed on May 31, 2021.

(51) Int. Cl. G05B 19/042; B60R 16/02; B60R 16/023; B60W 10/30; B60W 50/00

(52) U.S. Cl. CPC G05B 19/0426; B60R 16/0207; B60R 16/0231; B60W 10/30; B60W 50/00; B60W 2050/0083; G05B 2219/24116

(57) ABSTRACT

An accessory control system for a vehicle includes a controller configured to be installed on the vehicle and a wire harness connected to the controller to communicate output signals from the controller. The wire harness has an input connector and an output connector. The input connector is connected to the controller. The output connector is configured to be selectively connected to one of a first vehicle accessory and a second vehicle accessory. The output connector of the wire harness is configured to be disposed at a selected location on the vehicle. The controller is preprogrammed to transmit at least one first accessory signal through the wire harness to control the first vehicle accessory. The controller is configured to be reprogrammed to transmit at least one second accessory signal through the wire harness to control the second vehicle accessory.

### CROSS-REFERENCE

The present application claims priority from U.S. Provisional Patent Application No. 63/202,191, filed May 31, 2021, the entirety of which is incorporated by reference herein.

### TECHNOLOGICAL FIELD

The present technology relates to accessory control systems and kits for vehicles and to methods for configuring a vehicle.

### BACKGROUND

Off-road vehicles such as side-by-side vehicles (SSVs) are often equipped with optional accessories that are controlled by a control unit. For example, such powered accessories may include different types of lights, speakers, and an adjustable windshield amongst others.

Conventionally, in many cases, in order to install one of these accessories, a person has to install the accessory on the vehicle, then connect the accessory to a power source and finally connect a suitable switch or control device to the accessory in order to operate the accessory. However, as the accessory, the power source and the switch or control device are often disposed at different locations on the vehicle, this can be a long and tedious process requiring the installer to route electrical wires around the vehicle and in many cases having to remove body panels and reinstall body panels from the vehicle in order to conceal the wiring. As a result, the original look of the vehicle may be difficult to maintain, particularly when an untrained person attempts such an installation.

These problems may also apply to vehicles other than off-road vehicles.

Thus, there is a desire for an accessory control system for a vehicle that addresses some of the aforementioned drawbacks.

### SUMMARY

It is an object of the present technology to ameliorate at least some of the inconveniences present in the prior art.

According to an aspect of the present technology, there is provided an accessory control system for a vehicle. The accessory control system comprises: a controller configured to be installed on the vehicle; and a wire harness connected to the controller to communicate output signals from the controller, the wire harness having an input connector and an output connector, the input connector being connected to the controller, the output connector being configured to be selectively connected to one of a first vehicle accessory and a second vehicle accessory, the output connector of the wire harness being configured to be disposed at a selected location on the vehicle, the controller being preprogrammed to transmit at least one first accessory signal through the wire harness to control the first vehicle accessory, the controller being configured to be reprogrammed to transmit at least one second accessory signal through the wire harness to control the second vehicle accessory.

In some embodiments, the accessory control system further comprises a user input device in communication with the controller, the user input device being operable by a user to control operation of at least one of the first vehicle accessory and the second vehicle accessory.

In some embodiments, the user input device is a keypad, the keypad being operable by the user to cause the controller to transmit a given one of the at least one first accessory signal or a given one of the at least one second accessory signal.

In some embodiments, the controller has a port configured to be connected to an external computer for reprogramming the controller.

In some embodiments, the user input device is a touch screen, the touch screen being operable by the user to cause the controller to transmit a given one of the at least one first accessory signal or a given one of the at least one second accessory signal.

In some embodiments, the controller is reprogrammable via the touch screen.

In some embodiments, the controller is in communication with at least one sensor to receive at least one sensor input therefrom; the at least one first accessory signal or the at least one second accessory signal is generated by the controller based on the at least one sensor input; and an other one of the at least one first accessory signal and the at least one second accessory signal is not generated by the controller based on sensor inputs.

In some embodiments, the first vehicle accessory and the second vehicle accessory are different ones of: a light; an adjustable windshield; a heater; a speaker; a windshield wiper system; and a dust management system.

In some embodiments, the controller has a memory storing a first control program and a second control program; the first control program is configured to cause the controller to produce the at least one first accessory signal; the second control program is configured to cause the controller to produce that least one second accessory signal; the controller is preprogrammed to execute the first control program to transmit the at least one first accessory signal through the wire harness to control the first vehicle accessory; the controller is configured to be reprogrammed to execute the second control program to transmit the at least one second accessory signal through the wire harness to control the second vehicle accessory.

In some embodiments, the wire harness is a first wire harness, the output connector of the first wire harness being configured to be disposed at a first selected location on the vehicle; the accessory control system further comprises a second wire harness connected to the controller to communicate output signals from the controller, the second wire harness having an input connector and an output connector, the input connector of the second wire harness being connected to the controller, the output connector of the second wire harness being configured to be selectively connected to at least one other vehicle accessory, the output connector of the second wire harness being configured to be disposed at a second selected location on the vehicle different from the first selected location.

In some embodiments, the at least one other accessory is one of a third vehicle accessory and a fourth vehicle accessory, the controller being preprogrammed to transmit at least one third accessory signal through the second wire harness to control the third vehicle accessory, the controller being configured to be reprogrammed to transmit at least one fourth accessory signal through the second wire harness to control the fourth vehicle accessory.

In some embodiments, the output connector of the wire harness is a pin connector.

In some embodiments, the controller is configured to communicate with an electronic control unit (ECU) of the vehicle.

According to another aspect of the present technology, there is provided an accessory control kit for a vehicle. The accessory control kit comprises: a controller configured to be installed on the vehicle, the controller having a controller output port; and a wire harness configured to be connected to the controller to communicate output signals from the controller, the wire harness having an input connector and an output connector, the input connector being configured to be connected to the controller output port, the output connector being configured to be selectively connected to one of a first vehicle accessory and a second vehicle accessory, the output connector of the wire harness being configured to be disposed at a selected location on the vehicle, the controller being preprogrammed to transmit at least one first accessory signal through the controller output port to control the first vehicle accessory, the controller being configured to be reprogrammed to transmit at least one second accessory signal through the controller output port to control the second vehicle accessory.

In some embodiments, the accessory control kit further comprises a user input device configured to be in communication with the controller, the user input device being operable by a user to control operation of at least one of the first vehicle accessory and the second vehicle accessory.

In some embodiments, the user input device is a keypad, the keypad being operable by the user to cause the controller to transmit a given one of the at least one first accessory signal or a given one of the at least one second accessory signal.

In some embodiments, the controller has a port configured to be connected to an external computer for reprogramming the controller.

In some embodiments, the user input device is a touch screen, the touch screen being operable by the user to cause the controller to transmit a given one of the at least one first accessory signal or a given one of the at least one second accessory signal.

In some embodiments, the controller is reprogrammable via the touch screen.

In some embodiments, the controller is configured to be in communication with at least one sensor to receive at least one sensor input therefrom; the at least one first accessory signal or the at least one second accessory signal is generated by the controller based on the at least one sensor input; and an other one of the at least one first accessory signal and the at least one second accessory signal is not generated by the controller based on sensor inputs.

In some embodiments, the first vehicle accessory and the second vehicle accessory are different ones of: a light; an adjustable windshield; a heater; a speaker; a windshield wiper system; and a dust management system.

In some embodiments, the controller has a memory storing a first control program and a second control program; the first control program is configured to cause the controller to produce the at least one first accessory signal; the second control program is configured to cause the controller to produce that least one second accessory signal; the controller is preprogrammed to execute the first control program to transmit the at least one first accessory signal through the wire harness to control the first vehicle accessory; the controller is configured to be reprogrammed to execute the second control program to transmit the at least one second accessory signal through the controller output port to control the second vehicle accessory.

In some embodiments, the wire harness is a first wire harness, the output connector of the first wire harness being configured to be disposed at a first selected location on the vehicle; the controller output port is a first controller output port; the controller has a second controller output port; the accessory control kit further comprises a second wire harness configured to be connected to the controller to communicate output signals from the controller, the second wire harness having an input connector and an output connector, the input connector of the second wire harness being configured to be connected to the second controller output port, the output connector of the second wire harness being configured to be selectively connected to at least one other vehicle accessory, the output connector of the second wire harness being configured to be disposed at a second selected location on the vehicle different from the first selected location.

In some embodiments, the at least one other accessory is one of a third vehicle accessory and a fourth vehicle accessory, the controller being preprogrammed to transmit at least one third accessory signal through the second wire harness to control the third vehicle accessory, the controller being configured to be reprogrammed to transmit at least one fourth accessory signal through the second wire harness to control the fourth vehicle accessory.

In some embodiments, the output connector of wire harness is a pin connector.

In some embodiments, the controller is configured to communicate with an electronic control unit (ECU) of the vehicle.

According to another aspect of the present technology, there is provided a method for configuring a vehicle to be equipped with a second vehicle accessory in place of a first vehicle accessory, the vehicle having a controller connected to a wire harness, the wire harness having an input connector and an output connector, the input connector being connected to the controller, the output connector being configured to be selectively connected to one of the first vehicle accessory and the second vehicle accessory, the output connector of the wire harness being disposed at a selected location on the vehicle, the controller being preprogrammed to transmit at least one first accessory signal through the wire harness to control the first vehicle accessory. The method comprises: determining control features required to control the second vehicle accessory; identifying a control program operable to control the determined control features; and reprogramming the controller to execute the identified control program in order to transmit at least one second accessory signal through the wire harness to control the second vehicle accessory.

In some embodiments, the controller has a memory storing a first control program and a second control program; the first control program is configured to cause the controller to produce the at least one first accessory signal; the second control program is configured to cause the controller to produce the at least one second accessory signal; the controller is preprogrammed to execute the first control program to transmit the at least one first accessory signal through the wire harness; the identified control program is the second control program; and reprogramming the controller comprises reprogramming the controller to execute the second control program to cause the controller to transmit the at least one second accessory signal through the wire harness.

In some embodiments, the method further comprises connecting an external computer to the controller, the controller being reprogrammed via the external computer.

In some embodiments, the controller is in communication with a touch screen disposed in the vehicle, the controller being reprogrammed via the touch screen.

In some embodiments, the method further comprises connecting the second vehicle accessory to the output connector of the wire harness.

For purposes of the present application, terms related to spatial orientation when referring to a vehicle and components in relation to the vehicle, such as “forwardly”, “rearwardly”, “left”, “right”, “above” and “below”, are as they would be understood by a driver of the vehicle sitting thereon in an upright driving position, with the vehicle steered straight-ahead.

Embodiments of the present technology each have at least one of the above-mentioned objects and/or aspects, but do not necessarily have all of them. It should be understood that some aspects of the present technology that have resulted from attempting to attain the above-mentioned objects may not satisfy these objects and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view, taken from a top, front, left side, of a side-by-side vehicle according to an embodiment of the present technology;

FIG. 2 is a perspective view, taken from a top, front, right side, of the vehicle of FIG. 1;

FIG. 3 is a top plan view of the vehicle of FIG. 1;

FIG. 4 is a block diagram showing an accessory control system of the vehicle of FIG. 1;

FIG. 5 is a perspective view, taken from a top, front, right side, of a frame of the vehicle of FIG. 1 and the accessory control system to show a distribution of components the accessory control system relative to the frame;

FIG. 6 is a perspective view, taken from a top, front, right side, of the accessory control system of FIG. 5 in isolation from the remainder of the vehicle;

FIG. 7A is a block diagram illustrating an original programming of a controller of the accessory control system of FIG. 4;

FIG. 7B is a block diagram illustrating a modified programming of the controller of the accessory control system of FIG. 4; and

FIG. 8 is a block diagram illustrating a method for configuring the vehicle of FIG. 1 to be equipped with a new accessory.

### DETAILED DESCRIPTION

The present technology will be described with respect to a four-wheel, off-road vehicle 40 having two side-by-side seats and a steering wheel (i.e. a side-by-side vehicle (SSV)). However, it is contemplated that at least some aspects of the present technology may apply to other types of vehicles such as, but not limited to, off-road vehicles having a straddle seat and a handle bar (i.e. an all-terrain vehicle (ATV)), off-road vehicles having a single bucket-type seat, off-road vehicles with more than four wheels, and on-road vehicles having four or more wheels and having one or more seats, as well as other vehicles having ground-engaging members other than wheels (e.g., a tracked vehicle such as a snowmobile).

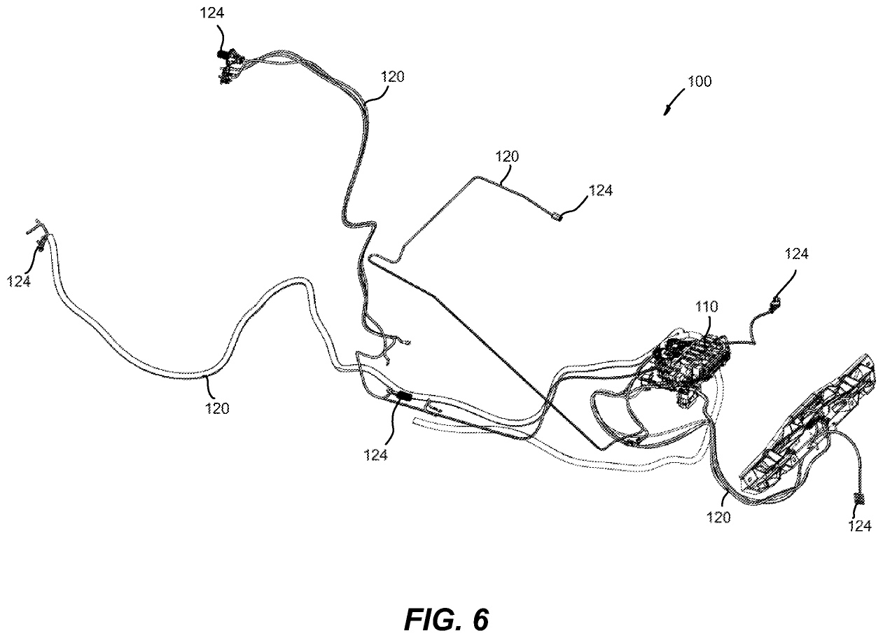

As will be described in greater detail below, the off-road vehicle 40 is provided with an accessory control system 100 (FIG. 6) to facilitate installation of one or more accessories on the vehicle 40. In particular, the accessory control system 100 allows an operator to easily and quickly add a new accessory or replace one accessory for another at a given location on the vehicle 40.

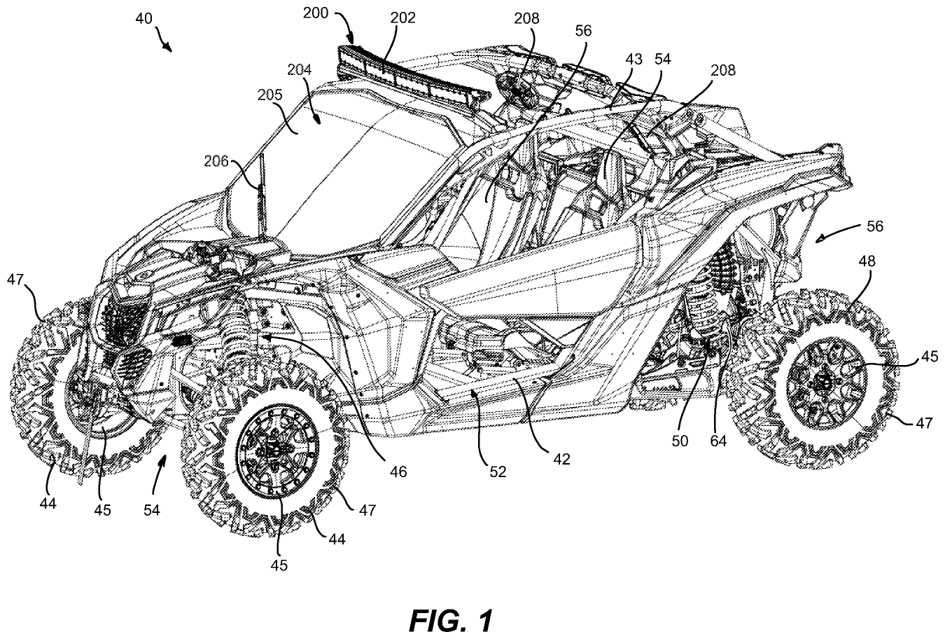

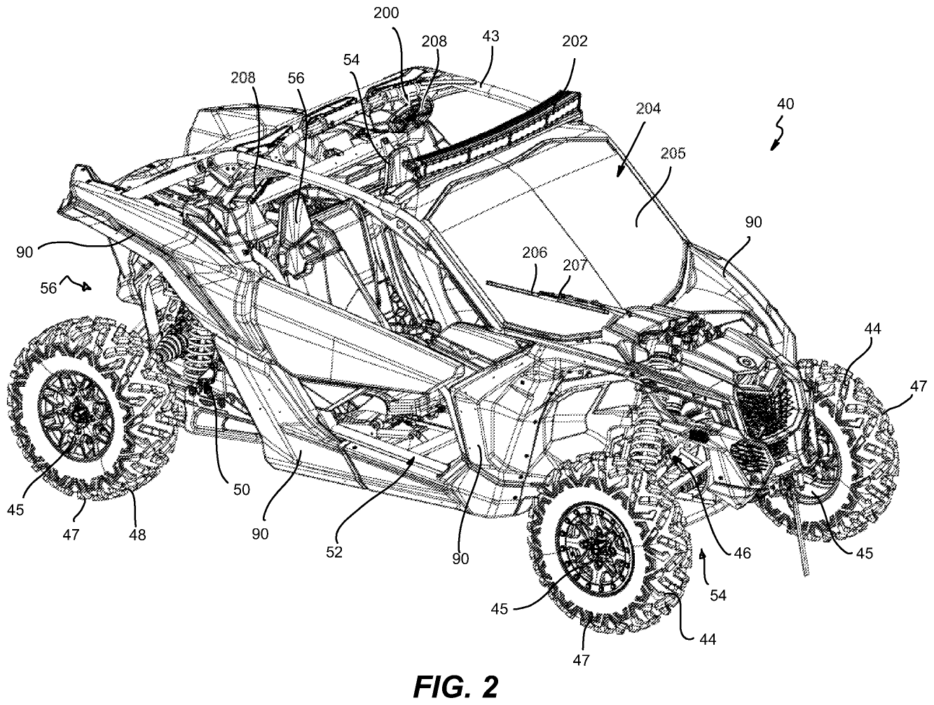

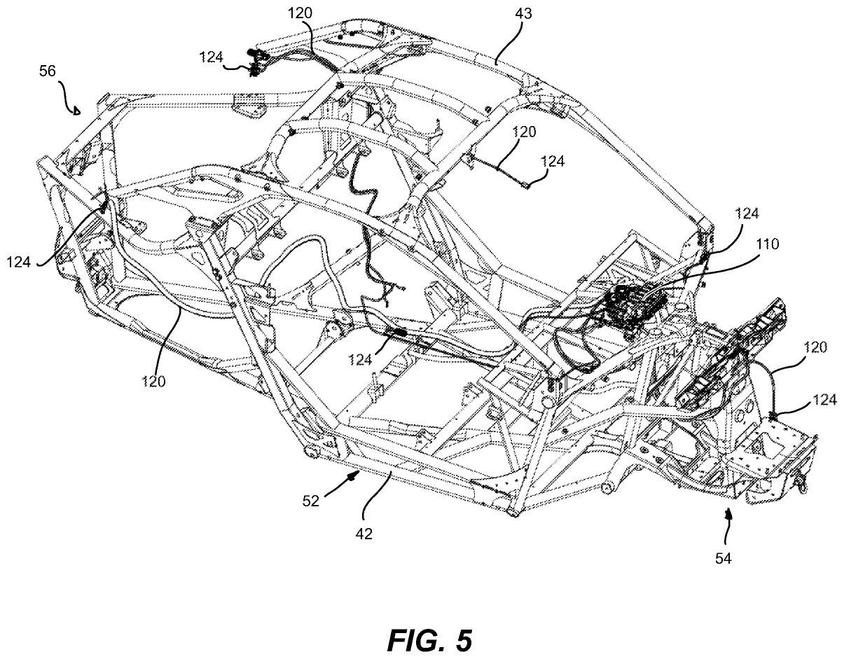

The general features of the off-road vehicle 40 will now be described herein with respect to FIGS. 1 to 3. The vehicle 40 has a frame 42. The frame 42 defines a central cockpit area 52 inside which are disposed a driver seat 54 and a passenger seat 56. In the present implementation, the driver seat 54 is disposed on the left side of the vehicle 40 and the passenger seat 56 is disposed on the right side of the vehicle 40. However, it is contemplated that the driver seat 54 could be disposed on the right side of the vehicle 40 and that the passenger seat 56 could be disposed on the left side of the vehicle 40. It is also contemplated that the vehicle 40 could include a single seat for the driver, or a larger number of seats, or a bench accommodating the driver and at least one passenger. The vehicle 40 also includes a roll cage 43 connected to the frame 42 and extending at least partially over the seats 54, 56. As best shown in FIG. 5, the frame 42 also has a front area 54 and a rear area 56 disposed forwardly and rearwardly of the central cockpit area 52 respectively.

The vehicle 40 includes left and right front wheels 44 connected to the frame 42 by a pair of front suspension assemblies 46. Left and right rear wheels 48 are connected to the frame 42 by a pair of rear suspension assemblies 50. Each one of the front and rear wheels 44, 48 has a rim 45 and a tire 47. The rims 45 and tires 47 of the front wheels 44 may differ in size from the rims and tires of the rear wheels 48. The vehicle 40 includes four brake assemblies (not shown), each one being operatively connected to a respective one of the wheels 44, 48. Each brake assembly includes a brake disc and a caliper disposed around its corresponding brake disc. Each caliper is connected to a corresponding brake line. Each caliper includes a pair of brake pads positioned on opposite sides of its respective brake disc. The brake assemblies are actuated by actuating the calipers by application of a fluid pressure in the brake lines, thereby causing the brake pads to apply pressure on their respective brake discs.

The vehicle 40 includes a steering wheel (not shown) operatively connected to the front wheels 44 for controlling a steering angle of the front wheels 44. The driver operates the steering wheel from the driver seat 54. The steering wheel is disposed in front of the driver seat 54. A steering position sensor (not shown) is operatively connected to the steering wheel, via a steering assembly, for determining a steering angle of the front wheels 44. The vehicle 40 also includes a dashboard (not shown) disposed forward of the seats 54, 56. A throttle operator in the form of a throttle pedal (not shown) is disposed over the floor of the cockpit area 52 below the steering wheel and in front of the driver seat 54. A pedal position sensor (not shown) is operatively connected to the throttle pedal to sense movement of the pedal caused by the driver in operation.

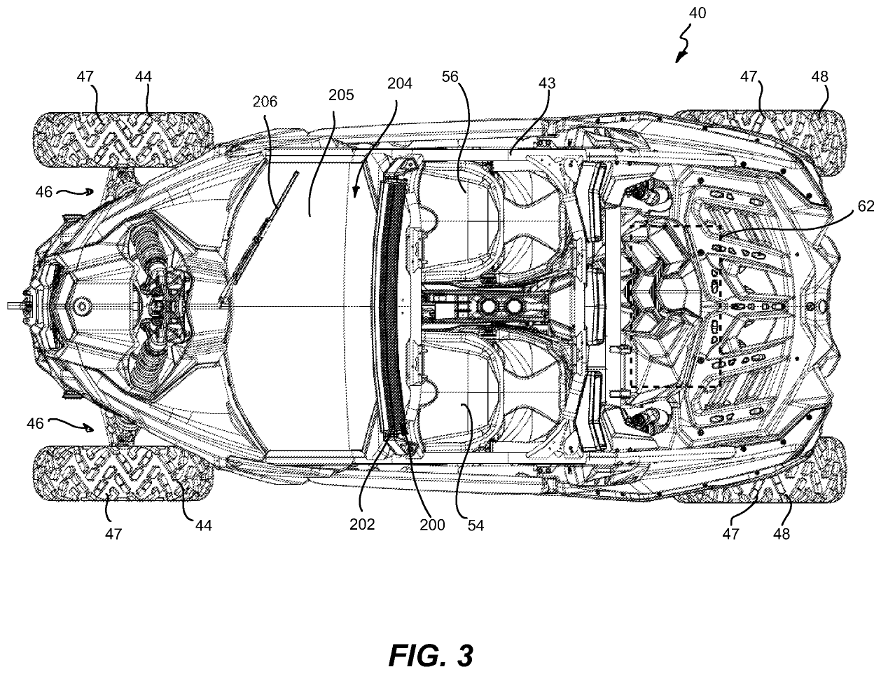

As shown schematically in FIG. 3, a motor 62 is connected to the frame 42 in a rear portion of the vehicle 40. In the present implementation, the motor 62 is an internal combustion engine but the present technology is not so limited. It is contemplated that the engine 62 could be replaced by a hybrid or electric motor in some implementations. The vehicle 40 includes an engine control module (ECM) for monitoring and controlling various operations of the engine 62. The ECM is communicatively connected to the pedal position sensor for receiving signals for controlling a throttle valve (not shown) of the engine 62. The engine 62 further includes a throttle position sensor (not shown) operatively connected to the throttle valve and communicatively connected to the ECM for monitoring the position of the throttle valve.

The motor 62 is connected to a transmission 64 (partially shown in FIG. 1), specifically a continuously variable transmission (CVT) 64 disposed on a left side of the motor 62. The CVT 64 is operatively connected to a transaxle (not shown) to transmit torque from the motor 62 to the transaxle. The transaxle is operatively connected to the front and rear wheels 44, 48 to propel the vehicle 40. The motor 62 and the transmission 64 are supported by the frame 42. Variants of the vehicle 40 having other transmission types are contemplated.

The transaxle is mechanically connected to a shifter (not shown) disposed laterally between the two seats 54, 56. The shifter allows the driver to select from a plurality of combinations of engagement of gears of the transaxle, commonly referred to as gears. In the present implementation, the shifter allows the driver to select between a reverse gear, two forward gears (high and low) and a neutral position in which the transaxle does not transmit torque to the wheels 44, 48. It is contemplated that other types of connections between the shifter and the transaxle could be used.

The transaxle transmits the torque applied thereon to drive the left and right rear wheels 48. While the vehicle 40 is described with the rear wheels 48 driving the vehicle 40 when in 2x4 drive mode, it is contemplated that the front wheels 44 could be driven when the vehicle 40 is in 2x4 drive mode in some implementations. Specifically, the transaxle is connected to left and right half-shafts and a differential connected therebetween for applying torque to the rear driven wheels 48. The differential is operatively connected between the transmission 64 and the left and right driven wheels 48. Furthermore, in a 4x4 drive mode, the front wheels 44 and the rear wheels 48 are driven.

A plurality of body panels 90 are provided on the vehicle 40 to conceal the internal components of the vehicle 40 and to enclose the cabin of the vehicle 40.

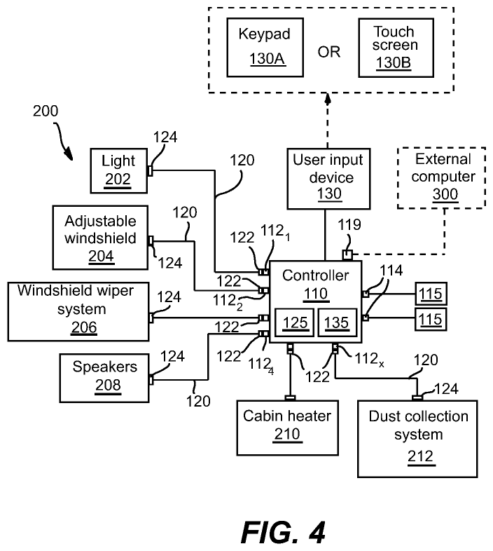

The vehicle 40 is provided with a plurality of accessories 200 which are selectively installed on the vehicle 40 via the accessory control system 100. In this embodiment, as shown in FIGS. 1 to 4, the accessories 200 include a light 202, an adjustable windshield 204, a windshield wiper system 206, two speakers 208, a cabin heater 210 (FIG. 4), and a dust collection system 212 (FIG. 4). Other accessories may be provided in other embodiments (e.g., additional lights or speakers, a seat heating system, an engine pre-filter particulate separator). The accessories 200 are installed on the vehicle 40 at different locations throughout the vehicle 40. For example, as shown in FIGS. 1 to 3, the light 202 is a light bar having light-emitting diodes (LEDs) and is disposed at the top of the roll cage 143 at a front portion thereof The adjustable windshield 204 is disposed at the front portion of the roll cage 43 and includes a windshield 205 and two actuators (not shown) which are connected to the windshield 205 to modify an angle of the windshield 205 relative to the roll cage 43. The windshield wiper system 206 is disposed forward of the windshield 205 to wipe the windshield 205 and includes a wiper 207 and a sprayer (not shown) to spray washer fluid onto the windshield 205. The speakers 208 include left and right speakers 208 which are disposed generally above and rearwardly of the driver and passenger seats 54, 56 respectively. The cabin heater 210 is configured to heat the driver and/or passenger seated at the driver and passenger seats 54, 56. Although not shown in FIGS. 1 to 3, the cabin heater 210 is positioned in front of the driver and passenger seats 54, 56. The dust collection system 212 is configured to aspirate dust and particles that find their way into the cabin of the vehicle 40. The dust collection system 212 is positioned at an appropriate position inside the cabin of the vehicle 40.

It is possible that a user may want to add a new accessory to the vehicle 40 or replace any one of the accessories 200 with another accessory. For example, in some cases, the user may want to add an additional light or replace one or both speakers 208 or the windshield wiper system 206 with a light. As will be explained below, this addition and/or replacement of accessories is facilitated by the accessory control system 100 which will now be described with reference to FIGS. 4 to 6.

The accessory control system 100 includes a controller 110 installed on the vehicle 40 and a plurality of wire harnesses 120 connected to the controller 110 to communicate output signals from the controller 110 to the different accessories 200. In this embodiment, as shown in FIG. 5, the controller 110 is positioned near a front portion of the vehicle 40 (e.g., forwardly of the driver and passenger seats 54, 56). As shown schematically in FIG. 4, the controller 110 has a plurality of controller output ports 112₁-112ₓ provided for outputting output signals from the controller 110 to the accessories 200 that are connected to the controller 110 via the wire harnesses 120. The controller 110 also has a plurality of controller input ports 114 provided for receiving sensor inputs from one or more sensors 115 configured for sensing parameters useful to control some of the accessories. For example, the sensors 115 may include a vehicle speed sensor for sensing a speed of the vehicle 40, a temperature sensor to sense an ambient temperature, or any other suitable sensor. The controller input ports 114 may be omitted in some embodiments (e.g., in cases in which the accessories to be installed on the vehicle do not require monitoring of sensor parameters).

In this embodiment, as shown in FIG. 4, the accessory control system 100 also includes a user input device 130 in communication with the controller 110. The user input device 130 is operable by a user to control operation of one or more of the accessories 200 that are connected to the controller 110. In this example, the user input device 130 is a keypad 130A having multiple buttons that can be actuated by the user to provide a control command to the controller 110. In turn, the controller 110 controls the accessories 200 connected thereto in accordance with the control commands communicated thereto via the keypad 130A. It is contemplated that, in other embodiments, the user input device 130 may be a touch screen 130B installed on the vehicle 40 and operable by the user by touching the screen 130B to provide the control commands to the controller 110.

With reference to FIG. 4, the controller 110 has a processor unit 125 for carrying out executable code, and a non-transitory memory unit 135 that stores the executable code in a non-transitory medium (not shown) included in the memory unit 135. The processor unit 125 includes one or more processors for performing processing operations that implement functionality of the controller 110. The processor unit 125 may be a general-purpose processor or may be a specific-purpose processor comprising one or more preprogrammed hardware or firmware elements (e.g., application-specific integrated circuits (ASICs), electrically erasable programmable read-only memories (EEPROMs), etc.) or other related elements. The non-transitory medium of the memory unit 135 may be a semiconductor memory (e.g., read-only memory (ROM) and/or random-access memory (RAM)), a magnetic storage medium, an optical storage medium, and/or any other suitable type of memory. While the controller 110 is represented as being one control unit in this implementation, it is understood that the controller 110 could comprise separate control units for controlling components separately and that at least some of these control units could communicate with each other. Moreover, in some embodiments, the controller 110 could be in communication with an electronic control unit (ECU) of the vehicle 40.

With continued reference to FIG. 4, each wire harness 120 has an input connector 122 and an output connector 124. The input connector 122 is connected to a corresponding controller output port 112ᵢ of the controller 110. The output connector 124 is selectively connected to one of the accessories 200. As shown in FIGS. 5 and 6, the wire harnesses 120 are arranged such that the output connectors 124 thereof are disposed at selected locations of the vehicle 40. In this embodiment, the output connectors 124 of the wire harnesses 120 are pin connectors having one or more rows of metal pins and/or holes (i.e., male or female pin connectors). Installing the wire harnesses 120 may require an operator to remove some of the body panels 90 from the vehicle 40 to route the wire harnesses 120 along the frame 42 (or inside the frame 42) such that the respective output connectors 124 are positioned at the desired locations of the vehicle 40. Once the wire harnesses 120 are installed, the accessories 200 can be connected to respective ones of the output connectors 124. This installation of the wire harnesses 120 is only done once, after which adding new accessories 200 to the vehicle 40 (or replacing other accessories after their installation) can be done using the same installed wire harnesses 120. The removal of body panels 90 from the vehicle 40 to install the accessory control system 100 is therefore only required at initial installation of the accessory control system 100.

The manner in which the controller 110 is programmed to control the different accessories 200 will now be described in detail.

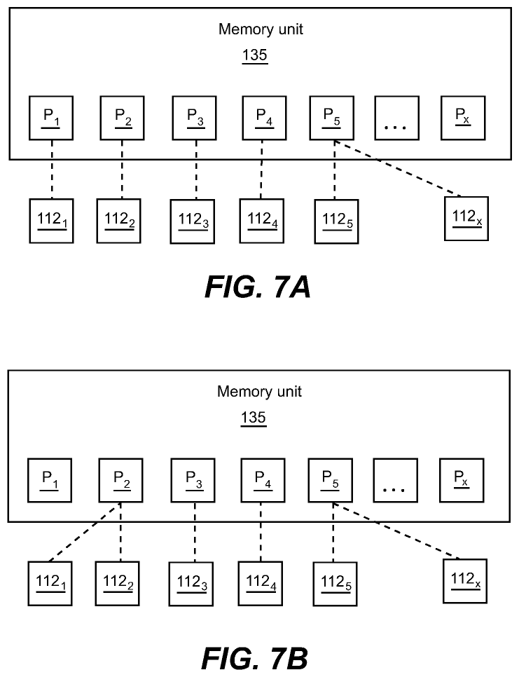

With reference to FIG. 7A, the controller 110 stores in its memory unit 135 multiple control programs P₁-Pₓ corresponding to the different accessories 200 which the controller 110 is configured to control. That is, each control program P₁-Pₓ is suitable to control a corresponding one of the accessories 200. To that end, each control program P₁-Pₓ controls one or more control features corresponding to one of the accessories 200 (or other accessories). For example, the control features controlled by the control programs P₁-Pₓ may include a temperature setting, a volume level, a light intensity, a windshield adjustment angle, or any other suitable control feature. As illustrated schematically in FIG. 7A, the controller 110 is preprogrammed to execute a particular one of the control programs P₁-Pₓ in association with each one of the controller output ports 112₁-112ₓ. It is to be noted that the number of control programs P₁-Pₓ may be greater than the number of controller output ports 112₁-112ₓ. Moreover, one of the control programs P₁-Pₓ may be associated with multiple ones of the controller output ports 112₁-112ₓ. Execution of one of the control programs P₁-Pₓ by the controller 110 causes the controller 110 to output, on its own or in response to inputs from the user via the user input device 130, one or more output signals through a corresponding controller output port 112ᵢ to control the accessory 200 connected to that controller output port 112ᵢ via a corresponding one of the wire harnesses 120. These output signals may be referred to as “accessory signals”. The controller 110 is therefore preprogrammed, via execution of the control programs P₁-Pₓ, to transmit respective accessory signals through each of its controller output ports 112₁-112ₓ to control the accessories 200 that are expected to be connected to those controller output ports 112₁-112ₓ via the wire harnesses 120 in accordance with an original programming of the controller 110. For instance, a user manual of the accessory control system 100 may inform the user of the original programming of the controller 110 so that the user knows which accessories 200 are expected to be connected to which output ports 112₁-112ₓ via the corresponding wire harnesses 120.

According to one example, a given control program P₁ of the plurality of control programs P₁-Pₓ is configured to control the light 202. For instance, the control program P₁ may be configured to control the light intensity of the light 202 (e.g., high, medium, low, or simply on/off). The controller 110 is preprogrammed to execute the control program P₁ in association with the output port 112₁. As such, the controller 110 transmits, through the controller output port 112₁ and the wire harness 120 connected thereto, accessory signals that are suitable for controlling the light 202. For example, the accessory signals transmitted through the controller output port 112₁ can cause the light 202 to simply turn on or off, or to increase/decrease in brightness. It is to be understood that execution of the other control programs P₁-Pₓ may output different accessory signals as different control parameters may have to be controlled for the other accessories 200.

It is to be noted that any given one of the control programs P₁-Pₓ can be configured for controlling a specific accessory 200 (i.e., an exact model of accessory such as a particular model of the light 202), or can be configured for controlling any accessory of a given accessory category (i.e., generic to a given accessory category such as any model of light). In addition, in some cases, any given one of the control programs P₁-Pₓ can be configured to control accessories from different accessory categories (e.g., configured to control the light 202 and the dust control system 212), such as for example when only an on/off signal is required to control the accessories.

The accessory signals transmitted by the controller 110 may be caused by inputs from the user communicated to the controller 110 via the user input device 130. In other words, the controls programs P₁-Pₓ may be responsive to the inputs from the user input device 130 to cause the controller 110 to transmit the accessory signals. In addition, some of the accessory signals generated by the controller 110 may be based at least in part on the sensor inputs received by the controller 110 from the sensors 115. Other ones of the accessory signals may not be generated by the controller 110 based on the sensor inputs. For instance, in one example, the accessory signals transmitted to the light 202 by the controller 110 are on/off signals based on user inputs at the keypad 130A. In another example, the accessory signals transmitted to the light 202 are automatically generated based on the sensor input of one of the sensors 115 (e.g., from a photocell configured to sense the amount of ambient light). In some cases, the accessory signals transmitted to the speakers 208 by the controller 110 are to regulate a volume of the speakers 208 based on user inputs at the keypad 130A. Additionally, the accessory signals transmitted to the speakers 208 by the controller 110 could regulate the volume of the speakers 208 based on a vehicle speed sensed by one of the sensors 115 (e.g., a greater vehicle speed being associated with a greater volume in order to compensate for the additional noise caused by the faster moving vehicle 40).

It is to be understood that the output connector 124 of a given one of the wire harnesses 120 could remain unplugged to any accessory after the initial installation of the accessory control system 100. In any case, the controller 110 is preprogrammed to control via that wire harness 120 (and thus the corresponding output port 112ᵢ) a particular type of accessory which is a likely accessory to be installed at the position of that output connector 124. For example, if the light 202 were not originally provided on the vehicle 40, the controller 110 would still be preprogrammed so that the output port 112ᵢ; corresponding to the output connector 124 located generally at the top of the roll cage 43 at the front portion thereof controls the light 202 as it is the most likely accessory to be installed at that location. Thus, in the event the user wishes to add a new accessory 200 to the vehicle 40, the user can connect the new accessory 200 to an unused output connector 124 (i.e., not plugged into any accessory) of one of the wire harnesses 120. If the original programming of the controller 110 is such that the unplugged output connector 124 and corresponding output port 112ᵢ, of the controller 110 are already associated with a control program Pₒ intended for the new accessory 200, then the user does not need to do anything else to install the new accessory 200 since the correct accessory signals will be transmitted to the new accessory 200. However, in the case where the user wishes to connect a different type of accessory to that unused output connector 124, the accessory control system 100 allows for the controller 110 to be reprogrammed to execute a different control program Pᵢ for controlling the new accessory in association with the corresponding output port 112ᵢ (instead of the original control program Pₒ that was originally associated with the output port 112ᵢ). As such, the controller 110 can be reprogrammed to transmit different accessory signals through a given one of the wire harnesses 120 to control a different accessory than what was originally intended for the corresponding output port 112ᵢ, and the associated wire harness 120. For instance, assuming the user wishes to connect a new accessory (e.g., a speaker, etc.) to the output port 112₁ and the controller 110 was originally preprogrammed to control the light 202 through the output port 112₁ via execution of the control program P₁ (the control program P₁ being a program suitable to control the light 202) in association with the output port 112₁, the controller 110 can be reprogrammed to execute a control program P₂ (the program P₂ being a program suitable to control the new accessory and different from the control program P₁) in association with the output port 112₁ instead of the control program P₁. This is illustrated in FIG. 7B which shows the association of the different control programs P₁-Pₓ with the output ports 112₁-112ₓ in a reprogrammed state relative to the original programming illustrated in FIG. 7A. The controller 110 can be reprogrammed in this manner for each of the output ports 112₁-112ₓ.

Similarly, in the event the user wishes to replace one of the accessories 200 that is connected to the controller 110 for another accessory, the user can disconnect the unwanted accessory from the output connector 124 of the corresponding wire harness 120 and connect the replacement accessory to that output connector 124 in its place. In the same manner as described above, the controller 110 can be reprogrammed, if needed, so that the correct control program Pᵢ is associated with the corresponding output port 112ᵢ and associated wire harness 120.

In some embodiments, the controller 110 may be reprogrammed to transmit, through one of its output ports 112₁-112ₓ, accessory signals that are based in part on one or more sensor inputs received from the sensors 115, even if the controller 110 was originally preprogrammed to transmit through that same one of the output port 112₁-112ₓ accessory signals that were not generated by the controller 110 based on sensor inputs.

In this embodiment, as shown in FIG. 4, the controller 110 is reprogrammable via an external computer 300. More specifically, the controller 110 has a port 119 that is configured to be connected to the external computer 300 for reprogramming the controller 110. For instance, the external computer 300 may be a computer available at a dealership responsible for servicing the vehicle 40 and may be operated by a qualified technician to reprogram the controller 110. In some embodiments, if a desired control program is not amongst the control programs P₁-Pₓ stored in the memory unit 135 of the controller 110, the desired control program may be uploaded to the memory unit 135 via the external computer 300 and can then be associated with the corresponding output port 112ᵢ.

In embodiments in which the user input device 130 is a touch screen 130B, the controller 110 may be reprogrammed via the touch screen 130B itself. For instance, a user or a technician may access a “settings” page that defines the associations of the various control programs P₁-Pₓ with the output ports 112₁-112ₓ and redefine the associations as desired. In some embodiments, if the desired control program is not amongst those stored in the memory unit 135, the user may remotely upload the desired control program onto the memory unit 135 via the touch screen.

In some embodiments, rather than reprogramming the controller 110 by changing the association of the output ports 112₁-112ₓ with the control programs P₁-Pₓ, the controller 110 could be reprogrammed by modifying the control programs P₁-Pₓ themselves to change the accessory signals that are generated by executing the control programs P₁-Pₓ. For example, assuming the control program P₁ is suitable for controlling the light 202 and the output port 112₁ is associated with the control program P₁, if the user wishes to connect to the output port 112₁ another type of light having different power requirements from the light 202, the user can reprogram the controller 110 by modifying the control program P₁ to change an output voltage transmitted through the output port 112₁. This reprogramming of the controller 110 can be done for example through the external computer 300.

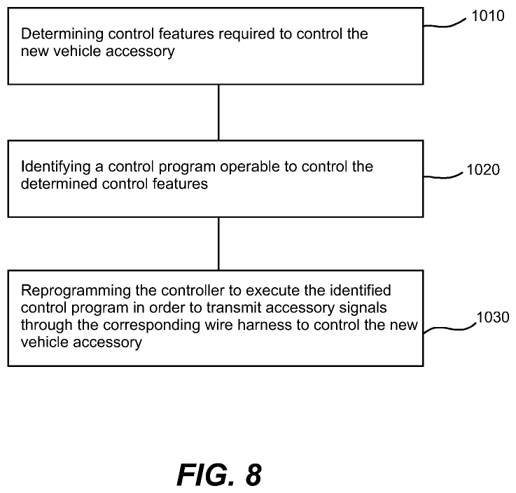

With reference to FIG. 8, a method for configuring the vehicle 40 to be equipped with a new accessory thus begins with, at step 1010, determining the control features required to control the new accessory. As described above, the control features may include one or more of a temperature setting, a volume level, a light intensity, a windshield adjustment angle, or any other control feature. Once the relevant control features have been identified, at step 1020, the appropriate control program Pᵢ is chosen, namely the control program Pᵢ that is operable to control the determined control features. At step 1030, the controller 110 is reprogrammed via the external computer 300 to execute the identified control program Pᵢ in order to transmit accessory signals associated with the new accessory through the corresponding output port 112ᵢ (and associated wire harness 120) and thereby control the new accessory.

By providing for the controller 110 to be reprogrammed in the manner described above, the user does not need to uninstall a wire harness 120 and install a new wire harness 120 in its place to install a new or replacement accessory as might be required in some conventional systems. As can be understood, this can greatly simplify installing a new accessory, notably as it can prevent the user having to remove body panels 90 from the vehicle 40 to install the new accessory. Instead, the original installation of the wire harnesses 120 and the controller 110 is done once at their initial installation (whether provided at original manufacturing of the vehicle 40 or installed later on). Furthermore, reprogramming the controller 110 in this manner is cost effective compared to some complex systems in which the accessories are designed to be automatically detected by a control unit upon connection thereto in order to use a correct program for control of the accessories.

It is contemplated that the controller 110 and the wire harnesses 120 may be sold as a kit to users as an aftermarket product so that the users can retrofit their vehicles with the accessory control system 100.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. An accessory control system for a vehicle, comprising:
a controller configured to be installed on the vehicle; and
a wire harness connected to the controller to communicate output signals from the controller, the wire harness having an input connector and an output connector, the input connector being connected to the controller, the output connector being configured to be selectively connected to one of a first vehicle accessory and a second vehicle accessory, the output connector of the wire harness being configured to be disposed at a selected location on the vehicle,
the controller being preprogrammed to transmit at least one first accessory signal through the wire harness to control the first vehicle accessory,
the controller being configured to be reprogrammed to transmit at least one second accessory signal through the wire harness to control the second vehicle accessory.

2. The accessory control system of claim 1, further comprising a user input device in communication with the controller, the user input device being operable by a user to control operation of at least one of the first vehicle accessory and the second vehicle accessory.

3. The accessory control system of claim 2, wherein the user input device is a keypad, the keypad being operable by the user to cause the controller to transmit a given one of the at least one first accessory signal or a given one of the at least one second accessory signal.

4. The accessory control system of claim 3, wherein the controller has a port configured to be connected to an external computer for reprogramming the controller.

5. The accessory control system of claim 2, wherein the user input device is a touch screen, the touch screen being operable by the user to cause the controller to transmit a given one of the at least one first accessory signal or a given one of the at least one second accessory signal.

6. The accessory control system of claim 5, wherein the controller is reprogrammable via the touch screen.

7. The accessory control system of claim 1, wherein:
the controller is in communication with at least one sensor to receive at least one sensor input therefrom;
the at least one first accessory signal or the at least one second accessory signal is generated by the controller based on the at least one sensor input; and
an other one of the at least one first accessory signal and the at least one second accessory signal is not generated by the controller based on sensor inputs.

8. The accessory control system of claim 1, wherein the first vehicle accessory and the second vehicle accessory are different ones of:
a light;
an adjustable windshield;
a heater;
a speaker;
a windshield wiper system; and
a dust management system.

9. The accessory control system of claim 1, wherein:
the controller has a memory storing a first control program and a second control program;
the first control program is configured to cause the controller to produce the at least one first accessory signal;
the second control program is configured to cause the controller to produce that least one second accessory signal;
the controller is preprogrammed to execute the first control program to transmit the at least one first accessory signal through the wire harness to control the first vehicle accessory;
the controller is configured to be reprogrammed to execute the second control program to transmit the at least one second accessory signal through the wire harness to control the second vehicle accessory.

10. The accessory control system of claim 1, wherein:
the wire harness is a first wire harness, the output connector of the first wire harness being configured to be disposed at a first selected location on the vehicle;
the accessory control system further comprises a second wire harness connected to the controller to communicate output signals from the controller, the second wire harness having an input connector and an output connector, the input connector of the second wire harness being connected to the controller, the output connector of the second wire harness being configured to be selectively connected to at least one other vehicle accessory, the output connector of the second wire harness being configured to be disposed at a second selected location on the vehicle different from the first selected location.

11. The accessory control system of claim 10, wherein:
the at least one other accessory is one of a third vehicle accessory and a fourth vehicle accessory,
the controller being preprogrammed to transmit at least one third accessory signal through the second wire harness to control the third vehicle accessory,
the controller being configured to be reprogrammed to transmit at least one fourth accessory signal through the second wire harness to control the fourth vehicle accessory.

12. The accessory control system of claim 1, wherein the output connector of the wire harness is a pin connector.

13. The accessory control system of claim 1, wherein the controller is configured to communicate with an electronic control unit (ECU) of the vehicle.

14. A method for configuring a vehicle to be equipped with a second vehicle accessory in place of a first vehicle accessory,
the vehicle having a controller connected to a wire harness, the wire harness having an input connector and an output connector, the input connector being connected to the controller, the output connector being configured to be selectively connected to one of the first vehicle accessory and the second vehicle accessory, the output connector of the wire harness being disposed at a selected location on the vehicle, the controller being preprogrammed to transmit at least one first accessory signal through the wire harness to control the first vehicle accessory,
the method comprising:
determining control features required to control the second vehicle accessory;
identifying a control program operable to control the determined control features; and
reprogramming the controller to execute the identified control program in order to transmit at least one second accessory signal through the wire harness to control the second vehicle accessory.

15. The method of claim 14, wherein:
the controller has a memory storing a first control program and a second control program;
the first control program is configured to cause the controller to produce the at least one first accessory signal;
the second control program is configured to cause the controller to produce the at least one second accessory signal;
the controller is preprogrammed to execute the first control program to transmit the at least one first accessory signal through the wire harness;
the identified control program is the second control program; and
reprogramming the controller comprises reprogramming the controller to execute the second control program to cause the controller to transmit the at least one second accessory signal through the wire harness.

16. The method of claim 14, further comprising connecting an external computer to the controller, the controller being reprogrammed via the external computer.

17. The method of claim 14, wherein the controller is in communication with a touch screen disposed in the vehicle, the controller being reprogrammed via the touch screen.

18. The method of claim 14, further comprising connecting the second vehicle accessory to the output connector of the wire harness.
